(19) United States
(12) Patent Application Publication
(10) Pub. No.: US 2017/0244595 A1
(43) Pub. Date: Aug. 24, 2017

(54) DYNAMIC DATA COLLECTION PROFILE CONFIGURATION

(71) Applicant: CA, Inc., New York, NY (US)

(72) Inventors: Seshadri Venkataraman, Union City, CA (US); Jonathan B. Lindo, Emerald Hills, CA (US)

(21) Appl. No.: 15/050,374

(22) Filed: Feb. 22, 2016

(51) Int. Cl. H04L 12/24; G06F 11/36; H04L 29/08

(52) U.S. Cl. CPC H04L 41/0803; H04L 67/303; G06F 11/3604

(57) ABSTRACT

Data generated by a first application analytics module in accordance with a first data collection profile is received. A triggering criterion is detected based, at least in part, on the data. In response to detection of the triggering criterion, a second data collection profile is generated. Availability of the second data collection profile is indicated to a second application analytics module.

### BACKGROUND

The disclosure generally relates to the field of computing systems, and more particularly to data collection.

Data collection is an important aspect of monitoring software application performance, behavior, etc. To collect data associated with a software application, the software application can be instrumented with code that generates the data at various points during the execution of the software application. The generated data can be stored on a device executing the software application and/or sent to an analytics server.

### BRIEF DESCRIPTION OF THE DRAWINGS

Aspects of the disclosure may be better understood by referencing the accompanying drawings.

FIG. 1 depicts an application analysis system having a dynamic data collection profile configuration.

FIG. 2 depicts an application analysis system having a dynamic data collection profile configuration using an in-application analytics module.

FIG. 3 depicts a flowchart of example operations for dynamically updating a data collection profile.

FIG. 4 depicts a flowchart of example operations for detecting triggering criteria.

FIG. 5 depicts an example computer system with an application analytics module with dynamic data collection profile configuration.

### DESCRIPTION

The description that follows includes example systems, methods, techniques, and program flows that embody aspects of the disclosure. However, it is understood that this disclosure may be practiced without these specific details. For instance, this disclosure refers to in-application analytics modules in illustrative examples. But aspects of this disclosure can be applied to analytics modules that operate independently of an application. In other instances, well-known instruction instances, protocols, structures and techniques have not been shown in detail in order not to obfuscate the description.

Software applications (hereinafter “applications”) can be analyzed for performance, behavior, and other characteristics. Typically, the application being analyzed (or a related component) generates data that describes various operational aspects of the application. For example, the application may generate data indicating how long each function/method call takes to execute, identifying an error or exception that occurred, or what data was resident in memory when a crash occurred.

The generated data can be stored locally (e.g., on a device executing the application) and/or can be stored remotely (e.g., in a database located on a remote server). Storing the data remotely allows administrators and analytics software to better monitor applications deployed across multiple devices. For example, the data can be aggregated, analyzed, and displayed on an application monitoring dashboard.

Applications can generate large amounts of data, much of which may be extraneous or unnecessary most of the time. For example, generating data identifying each function executed and how long execution of each function took may be unnecessary unless there is a known performance problem. Similarly, data used for identifying the causes of a crash may be unnecessary if the application has been stable (e.g., crashes rarely). To reduce the amount of data generated and, if stored remotely, transmitted over a network, an application can generate data based on a “data collection profile.” The data collection profile indicates when an application should generate data and/or what kind of data should be generated. Generating and/or transmitting data based on the data collection profile is referred to as “collecting” the data.

An administrator (or other user) may modify the data collection profile when the administrator determines that additional data may be useful. For example, if the administrator determines that an application is experiencing a performance problem (e.g., running slow), the administrator may enable the collection of performance data from the application. This technique is reactive, e.g., reliant on the administrator to identify the problem and update the data collection profile.

An application analysis system, however, can implement a proactive technique for data collection. More particularly, an application analysis system uses rule-based techniques and/or machine-learning techniques (e.g., statistical analysis, heuristics, etc.) to detect triggering criteria (detection of a potential anomaly, for example). In response to detecting the triggering criteria, the application analysis system modifies the data collection profile to begin collecting data relevant to the triggering criteria. The application analysis system can also alert the administrator that the triggering criteria were detected. The application analysis system can implement a rule-based system that works in conjunction with the machine-learning techniques to allow an administrator to specify the changes that should be made to the data collection profile in response to detecting particular triggering criteria.

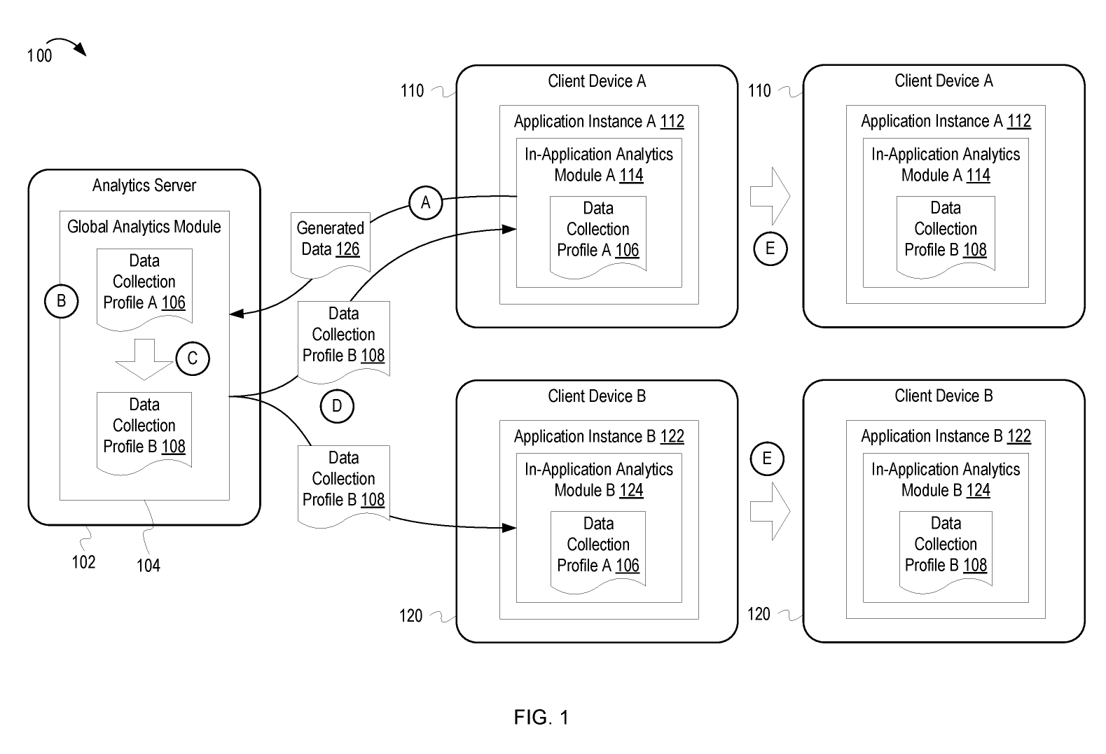

FIG. 1 depicts an application analysis system having a dynamic data collection profile configuration. FIG. 1 depicts an application analysis system 100, including an analytics server 102 and two client devices (client device A 110 and client device B 120). The analytics server includes a global analytics module 104. Client device A 110 and client device B 120 each include an instance of an application (application instance A 112 and application instance B 122, respectively). Application instance A 112 and application instance B 122 each include an in-application analytics module (in-application analytics module A 114 and in-application analytics module B 124, respectively). The global analytics module 104 and in-application analytics modules are examples of application analytics modules.

Initially, the global analytics module 104 and each of the in-application analytics modules includes data collection profile A 106. Data collection profile A 106 identifies the data that is collected by the in-application analytics modules and sent back to the global analytics module 104. Data collection profile A 106 may be a default data collection profile that is included with each of the in-application analytics modules or may have been sent to the in-application analytics modules by the global analytics module 104.

At stage A, client device A 110 generates data in accordance with data collection profile A 106 and sends the generated data 126 to the global analytics module 104. The generated data 126 sent to the global analytics module 104 may be a subset of the data generated by the in-application analytics module A 114. For example, the in-application analytics module A 114 or application instance A 112 may generate data that is saved to storage (not depicted) on client device A 110 and then filtered based on data collection profile A 106. The generated data 126 can include any type of data that is useful in monitoring an application. For example, the generated data 126 may include data associated with client device A 110, such as hardware specification, software specifications, device identifier(s), etc. The generated data 126 may include data useful for root cause analysis, such as stack traces and memory dumps. The generated data 126 may include performance data, such as the execution time of functions called by application instance A 112, network data transfer rates, data transfer amounts, network latency, etc. The generated data 126 may include information identifying a user, such as a user identifier or session identifier, or information identifying user interactions, such as event identifiers, gesture identifiers, etc.

At stage B, the global analytics module 104 detects one or more triggering criteria based, at least in part, on the generated data 126. To detect a triggering criterion, the global analytics module 104 analyzes the generated data 126. The specific analysis technique used can vary. For example, in-application analytics module A 114 may explicitly identify or tag triggering criterion in the generated data 126. As another example, the global analytics module 104 may use rule-based analysis techniques. In rule-based analysis, rules specify what data should be analyzed and the triggering criteria. For example, a rule may specify that an application crash rate (the data) over a particular threshold is a triggering criterion. As another example, a rule may specify that a data transfer rate that decreases at a certain rate is a triggering criterion.

Machine-learning techniques, such as statistical analysis and heuristics, can be used in conjunction with the rules. For example, a rule can identify the data and specify that the triggering criteria are any abnormality in the data. The global analytics module 104 may then analyze the data using machine-learning techniques to identify abnormalities. For example, statistical analysis may be used to identify variations or trends in data that typically remains fairly consistent, such as data transfer rate or latency. Statistical analysis can be used to identify spikes, prolonged upwards or downwards trends, etc.

At stage C, the global analytics module 104 generates a new data collection profile based, at least in part, on the triggering criteria. In particular, the global analytics module 104 determines a set of data associated with the triggering criterion. For example, a rule that was identified during stage B may identify the set of data associated with the triggering criteria detected at stage B. In other words, the rule may identify a relationship (e.g., map) between triggering criteria and data associated with the triggering criteria. Other mapping structures (e.g., mapping tables) may also be used.

After determining the set of data associated with the triggering criteria, the global analytics module 104 generates data collection profile B 108, which identifies the set of data. The global analytics module 104 can generate data collection profile B 108 by modifying data collection profile A 106 to include the data associated with the triggering criterion. For example, data collection profile A 106 may include a list of identifiers that identify data that should be collected and the rule may specify a list of identifiers that should be added when one or more rule criteria are triggered. Thus, to generate data collection profile B 108, the global analytics module 104 may add the list of identifiers from the rule to the list of identifiers included in data collection profile A 106. Data collection profile B 108 can be generated by modifying data collection profile A 106 directly or generating a new data collection profile independent of data collection profile A 106.

At stage D, the global analytics module 104 sends data collection profile B 108 to in-application analytics module A 114 and in-application analytics module B 124. Sending data collection profile B 108 to both in-application analytics modules allows the global analytics module 104 to collect data from application instances other than the one that generated the triggering criteria. In some instances, it may not be beneficial to send the generated data collection profile to multiple devices and/or multiple application instances. In such instances, the global analytics module 104 can send the generated data collection profile to the in-application analytics module that generated the data with the triggering criteria without sending the generated data collection profile to other in-application analytics modules. For example, if the triggering criterion detected at stage B was related to a potential security breach on client device A 110, the global analytics module 104 may create a data collection profile specifically for in-application analytics module A 114 and send the data collection profile to in-application analytics module A 114 only.

At stage E, in-application analytics module A 114 and in-application analytics module B 124 update their respective configurations based, at least in part, on data collection profile B 108. After updating their configurations, the in-application analytics modules will generate and send data to the global analytics module 104 based, at least in part, on data collection profile B 108 instead of data collection profile A 106.

As described above, modifying a data collection profile is usually performed by an administrator when the administrator determines that a problem has occurred. However, because the global analytics module 104 performs the analysis on the received data, the global analytics module 104 can modify the data collection profile prior to an administrator determining that a problem has occurred.

The new data collection profile B 108 generally configures the in-application analytics modules to generate data related to the triggering criteria. For example, if a triggering criterion is a crash rate exceeding a threshold, data collection profile B 108 may indicate that memory dumps and stack traces should be collected. The memory dumps and stack traces can then be used to diagnose the cause of the crashes.

Although FIG. 1 depicts each of the in-application analytics modules as having the same data collection profile, the data collection profiles may differ between in-application analytics modules. For example, if client device A 110 is a smartphone and client device B 120 is a tablet computer, the data collection profile for each may be different in some respects. In such implementations, when the global analytics module 104 detects triggering criteria, the global analytics module 104 can modify the data collection profile that corresponds to each of the devices accordingly and send the modified data collection profile to the corresponding device.

Additionally, some implementations may include analytics modules on the client devices that execute independently of the application instances in place of or in conjunction with the in-application analytics modules.

Further, although the generated data 126 is depicted as being transmitted from in-application analytics module A 114 to the global analytics module 104 at stage A, the generated data 126 may be a portion of an ongoing data stream. Thus, the generated data 126 may be sent to the global analytics module 104 in parallel with other stages/operations and may be a subset of a stream of data.

In some implementations, the global analytics module 104 may process the generated data 126 after receiving the data and before analyzing the data. For example, the global analytics module 104 may aggregate the generated data 126 with data generated by in-application analytics module B 124 or data previously generated by in-application analytics module A 114. The global analytics module 104 may add the generated data 126 to historical data.

Some triggering criteria may be based on data that is aggregated from multiple in-application analytics modules. For example, the number of application crashes across all devices running an instance of that application may be determined based on data generated by the corresponding in-application analytics modules. Because a global analytics module, as described above, receives data from the individual in-application analytics modules, the global analytics module is typically responsible for detecting trigger criteria based on aggregated data from multiple devices.

Some triggering criteria may be based on data that is specific to a single device. For example, a triggering criterion might be a determination, based on user access information, that a new user is using an application on the device. Because the in-application analytics module has access to the generated data, the in-application analytics module can detect the triggering criteria instead of the global analytics module. After detecting the triggering criteria, the in-application analytics module updates the local data collection profile. The in-application analytics module then notifies the global analytics module that the trigger criteria were detected. In response, the global analytics module generates a new data collection profile based on the detected trigger criteria. After generating the new data collection profile(s), the global analytics module determines whether the generated data collection profile(s) should be sent to other in-application analytics modules. If the global analytics module determines that the generated data collection profile(s) should be sent to other in-application analytics modules, the global analytics sends the generated data collection profile(s) accordingly.

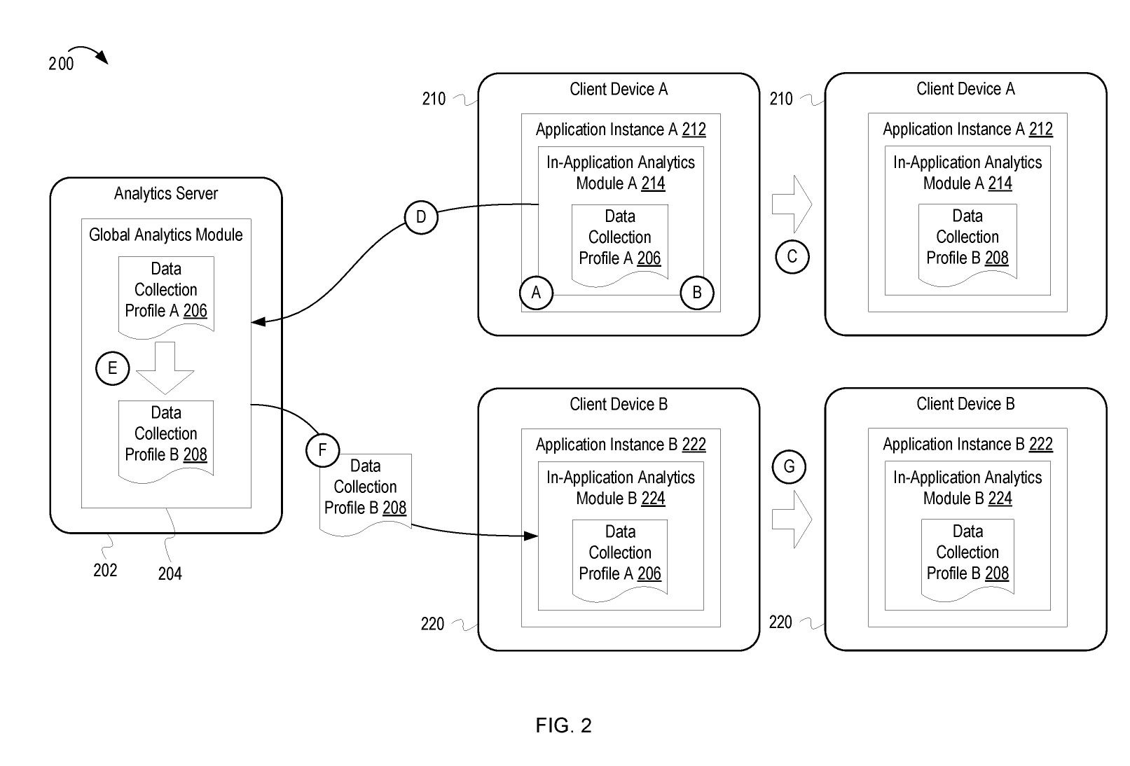

FIG. 2 depicts an application analysis system having a dynamic data collection profile configuration using an in-application analytics module. FIG. 2 depicts an application analysis system 200, including an analytics server 202 and two client devices (client device A 210 and client device B 220). The analytics server 202 includes a global analytics module 204. Client device A 210 and client device B 220 each include an instance of an application (application instance A 212 and application instance B 222, respectively). Application instance A 212 and application instance B 222 each include an in-application analytics module (in-application analytics module A 214 and in-application analytics module B 224, respectively). The global analytics module 204 and the in-application analytics modules are examples of application analytics modules. The initial configuration of the application analysis system 200 can be substantially similar to the initial configuration of the application analysis system 100 of FIG. 1.

At stage A, in-application analytics module A 214 generates data in accordance with data collection profile A 206. The operations performed by in-application analytics module A 214 can be substantially similar to the operations performed by in-application analytics module A 114 at stage A of FIG. 1.

At stage B, in-application analytics module A 214 detects one or more triggering criteria based, at least in part, on the data generated at stage A. The operations performed by in-application analytics module A 214 can be substantially similar to the operations performed by the global analytics module 104 at stage B of FIG. 1.

At stage C, in-application analytics module A 214 generates a new data collection profile (data collection profile B 208) based, at least in part, on the triggering criteria. The operations performed by in-application analytics module A 214 to generate data collection profile B 208 can be substantially similar to those performed by the global analytics module 104 at stage C of FIG. 1. After generating data collection profile B 208, in-application analytics module A 214 updates its configuration based, at least in part, on data collection profile B 108.

At stage D, in-application analytics module A 214 notifies the global analytics module 204 of the triggering criteria. The mechanism used by in-application analytics module A 214 to notify the global analytics module 204 of the triggering criteria can vary. For example, in-application analytics module A 214 may send the data generated at stage A, send the updated data collection profile (i.e., data collection profile B 208), and/or send an indication of the triggering criteria (e.g., a rule identifier corresponding to a rule used at stage B to detect the triggering criteria).

The global analytics module 204 may maintain a data collection profile for each in-application analytics module in the application analysis system 200. At stage E, the global analytics module 204 updates its local copy of the data collection profile corresponding to in-application analytics module A 214. When the global analytics module 204 determines that in-application analytics module A 214 is configured to use data collection profile B 208, the global analytics module 204 updates the data collection profile it maintains for in-application analytics module A 214. The global analytics module 204 may also determine that a global data collection profile should be updated as well. In some implementations, the global analytics module 204 only maintains a global data collection profile and thus does not update a data collection profile that specifically corresponds to in-application analytics module A 214.

At stage F, the global analytics module 204 determines that data collection profile B 208 should be sent to other in-application analytics modules of the application analysis system 200. In response to determining that data collection profile B 208 should be sent to other in-application analytics modules, the global analytics module 204 sends data collection profile B 208 to in-application analytics module B 224.

At stage G, in-application analytics module B 224 updates its configuration based, at least in part, on data collection profile B 108.

The operations depicted in FIG. 2 are generally similar to those depicted in FIG. 1. However, the operations depicted in FIG. 2 are adapted for implementations in which the in-application analytics modules detect triggering criteria. The embodiments described in FIGS. 1 and 2 can be combined. Thus, in some implementations, a global analytics module and one or more in-application analytics modules can detect the triggering criteria.

FIGS. 1 and 2 are annotated with a series of letters, A through E and A through G, respectively. These letters represent stages of operations. Although these stages are ordered for these examples, the stages illustrate two examples to aid in understanding this disclosure and should not be used to limit the claims. Subject matter falling within the scope of the claims can vary with respect to the order and some or all of the operations.

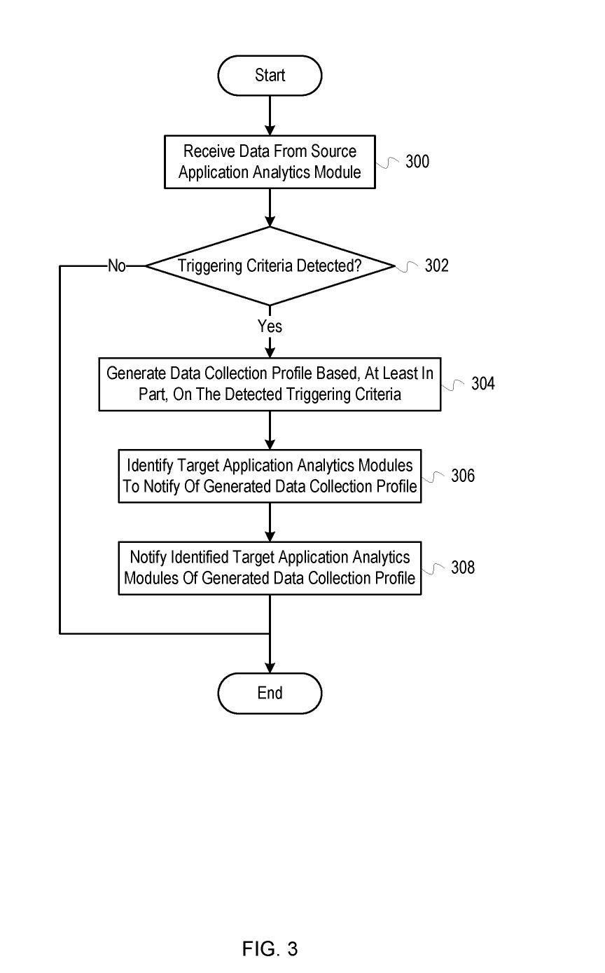

FIG. 3 depicts a flowchart of example operations for dynamically updating a data collection profile. The operations of FIG. 3 can be performed by an application analytics module, such as a global analytics module (e.g., global analytics modules 104 and 204 of FIGS. 1 and 2, respectively), an in-application analytics module (e.g., in-application analytics module A 114 and 214 of FIGS. 1 and 2, respectively), or any suitable component.

An application analytics module receives data from a source application analytics module (300). In some instances, the source application analytics module may be an application analytics module located on another device. For example, the source application analytics module may be an in-application analytics module and the application analytics module may be a global analytics module. In some instances, the source application analytics module may be the same as the application analytics module. For example, an in-application analytics module may receive data generated by itself.

After receiving the data from the source application analytics module, the application analytics module determines whether triggering criteria has been detected (302). The particular technique used to detect the triggering criteria can vary depending on the data received. For example, the data may explicitly identify triggering criteria or the application analytics module may analyze the data to determine whether a rule matches the data. If the application analytics module detects triggering criteria, control flows to block 304. If the application analytics module does not detect triggering criteria, the process ends.

If the application analytics module detected triggering criteria, the application analytics module generates a data collection profile based, at least in part, on the detected triggering criteria (304). The application analytics module may generate the data collection profile by identifying data associated with the triggering criteria. For example, a rule may include or reference data that should be included in a data collection profile if the criteria of the rule is triggered. Once the data is identified, the application analytics module can generate the data collection profile by adding the data to an existing data collection profile or generating a separate data collection profile that includes the data specified in the existing data collection profile and the data associated with the triggering criteria. In some instances, the application analytics module may generate a data collection profile solely from the data associated with the triggering criteria without using an existing data collection profile.

After generating the data collection profile, the application analytics module identifies one or more target application analytics module(s) to notify of the generated data collection profile (306). The particular target application analytics modules identified may vary depending on the triggering criteria and/or generated data collection profile. For example, the generated data collection profile may be a global data collection profile that applies to all devices associated with the application analytics module, resulting in identification of all in-application analytics modules. As another example, the generated data collection profile may be a local data collection profile that applies to a single device or single device type associated with the application analytics module, resulting in identification of one or more particular devices. As another example, the generated data collection profile may apply to a categorical subset of the devices associated with the application analytics module (e.g., all devices running a particular operating system).

After identifying the target application analytics modules to notify of the generated data collection profile, the application analytics module notifies the identified target application analytics modules (308). The particular operations performed to notify the identified target application analytics modules can vary. For example, the application analytics module may send a message that includes the generated data collection profile, may send data that will cause the generated data collection profile to be generated by the target application analytics modules, send a message indicating that a new data collection profile is available to be downloaded by the target application analytics modules, etc. After the identified target application analytics modules are notified, the process ends.

Application analytics modules that receive a notification of a generated data collection profile can perform operations similar to those of blocks 306 and 308. For example, if a global analytics module receives a notification that an in-application analytics module has updated its data collection profile (as depicted in FIG. 2), the global analytics module may identify which other application analytics modules should be notified of the updated data collection profile.

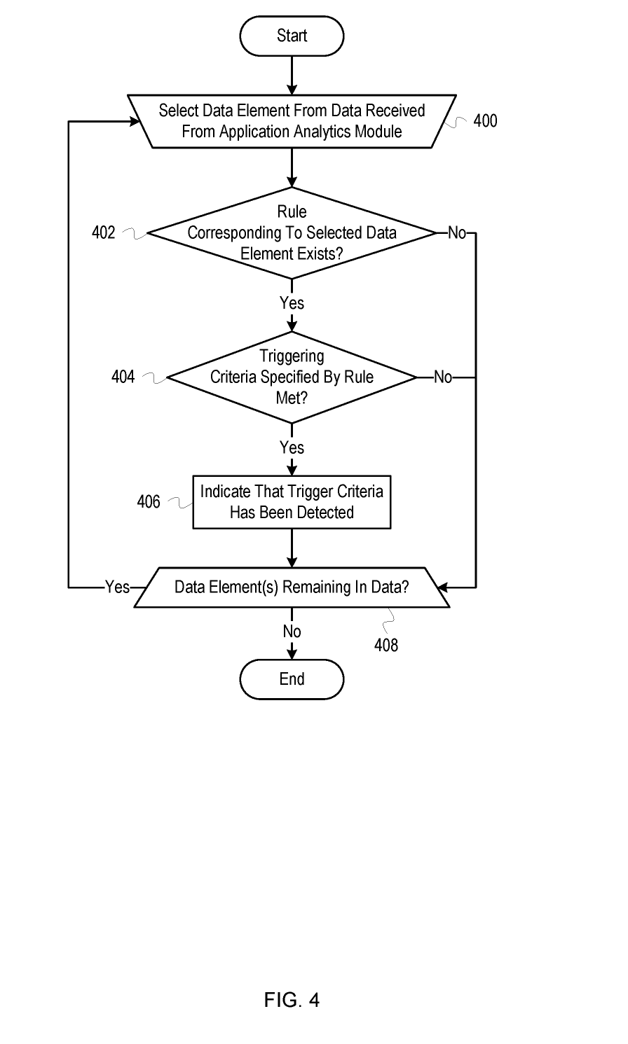

FIG. 4 depicts a flowchart of example operations for detecting triggering criteria. The operations of FIG. 4 can be performed by an application analytics module, such as a global analytics module (e.g., global analytics modules 104 and 204 of FIGS. 1 and 2, respectively), an in-application analytics module (e.g., in-application analytics module A 114 and 214 of FIGS. 1 and 2, respectively), or any suitable component.

After receiving data from a source application analytics module as described at block 300 of FIG. 3, an application analytics module selects a data element from the data (400). The application analytics module also selects a data element from the data after determining that additional data element(s) remain in the data at block 408.

After selecting a data element from the data, the application analytics module determines whether a rule corresponding to the selected data element exists (402). For example, the selected data element may be identified by a key. The application analytics module may search through a set of rules to identify a rule that includes the key. If the application analytics module determines that a rule corresponding to the selected data element exists, control flows to block 404. If the application analytics module determines that no rule corresponding to the selected data element exists, control flows to block 408.

If the application analytics module determined that a rule corresponding to the selected data element exists, the application analytics module determines whether the triggering criteria specified by the rule are met (404). The particular operations performed by the application analytics module to determine whether the triggering criteria are met can vary. For example, if the rule specifies a threshold, the application analytics module may determine whether the data element includes a value that exceeds the threshold. As another example, if the rule specifies that an abnormality in the data is a triggering criterion, the application analytics module may apply machine-learning or other techniques to determine whether the received data is indicative of an abnormality. If the application analytics module determines that the triggering criteria specified by the rule are met, control flows to block 406. If the application analytics module determines that the triggering criteria specified by the rule are not met, control flows to block 408.

If the application analytics module determined that the triggering criteria specified by the rule are met, the application analytics module indicates that the trigger criteria have been detected (406). The particular operations performed by the application analytics module to indicate that the trigger criteria have been detected can vary. For example, the application analytics module may explicitly indicate that the trigger criteria has been detected by passing a value between functions or methods (e.g., as a return value). The application analytics module may implicitly indicate that the trigger criteria have been detected by performing a specific set of operations.

If the application analytics module determines that the rule corresponding to the selected data element does not exist, determines that the triggering criteria specified by the rule is not met, or indicates that the trigger criteria has been detected, the application analytics module then determines whether any data element(s) remain in the data. If the application analytics module determines that data elements remain in the data, control flows back to block 400. If the application analytics module determines that no data elements remain in the data, the process ends.

### Rules Examples

This section provides additional examples of rules that may trigger generation of a data collection profile in addition to the examples discussed above. Due to the variety of rules that may be useful, the examples described herein do not constitute all possible examples.

An application analysis system may analyze numerous network components to ensure that various aspects of a network used for communications between components (e.g., a device running an application being analyzed and a server with which the application communicates) work as intended. If the application analysis system determines that the network is performing as intended and that the performance has remained stable for a sufficient period of time, the application analysis system may stop analyzing the network (which may be embodied in a rule). However, the application analysis system may implement a rule that triggers a data collection profile change if communications from a different locale are detected. For example, an application being analyzed may typically be located on devices located within North America. If the application analysis system detects that data is being transmitted from locations within Southeast Asia, the application analysis system may begin analyzing the network(s) used to transmit data from Southeast Asia, which may differ from the network(s) used to transmit data from North America. In some implementations, the application analysis system may notify an administrator or other user that application data is being transmitted from a locale that uses a different network. In some implementations, the application analysis system may only notify the administrator or other user if additional analysis indicates that the network is not performing as preferred (e.g., after the data collection profile is modified in response to detecting the new location). Thus, a set of rules may be implemented to analyze previously unanalyzed networks when use of the previously unanalyzed networks is detected and to halt analysis after determining that the previously unanalyzed networks are operating with sufficient performance and/or stability.

Other locale-based rules may also be implemented. For example, if a locale is known to be a common source of hacking attempts, the application analysis system may generate a data collection profile that results in collection of data useful for detecting security breaches if the application analysis system determines that data is being received from such a locale.

Many applications allow for detecting data at variable granularity. For example, an application may have the following levels of granularity (from coarse to fine): “critical”, “error”, “warning”, and “debug”. The application may include instrumentation that generates data based, at least in part, on which level of granularity the application is configured for. For example, if the application is set to the “debug” level of granularity, any instrumentation identified as “critical”, “error”, “warning”, or “debug” will generate data; if the application is set to the “warning” level of granularity, any instrumentation identified as “critical”, “error”, or “warning” will generate data; if the application is set to the “error” level of granularity, any instrumentation identified as “critical” or “error” will generate data; and if the application is set to the “critical” level of granularity, only instrumentation identified as “critical” will generate data. Although finer grained data provides more complete information, it produces information that may be unnecessary. Thus, applications are typically configured to generate data at as coarse of a granularity as possible (e.g., a product in development may be set to “debug” while a mature, stable product may be set to “critical”). Applications may also generate error “fingerprints” when an error occurs. The error fingerprint can vary, but may consist of data useful for identifying the error, such as a file and line number, an error number, variable values (e.g., value of a program counter), etc. If the application analysis system detects an error fingerprint that has not been previously encountered or is related to an error previously thought to be resolved, the application analysis system may generate a data collection profile that increases the granularity of the data that the application generates (e.g., from “critical” to “debug”).

Rules may also take into account external events or data as well. For example, the application analysis system may receive notifications when a new version of an application is released or when a new marketing campaign has begun. In response, the application analysis system may generate a data collection profile that generates data relevant to the external event/data (e.g., increasing the granularity of the data collected).

As mentioned above, user interaction may trigger the generation of a data collection profile. For example, an application analytics module might track typing characteristics (e.g., typing patterns, typing speed, etc.) of a user that typically accesses a particular device. If the application analytics module determines that the typing characteristics have changed, the application analytics module might generate a new data collection profile. As another example, an application analytics module might generate a new data collection profile if the application analytics module detects a certain number of failed login attempts.

Rules can also be used to modify the amount of data collected based on available bandwidth. For example, if a device being analyzed is a mobile device, an application analytics module may reduce the amount of data collected if the device is using a cellular connection instead of a wireless local area network connection.

### Data Collection Profile Examples

Due to the possible variability in the contents of a data collection profile, the examples above only provide enough details to make the examples clear (i.e., additional details are omitted to avoid obfuscating the examples). This section will provide some additional examples of data collection profiles, but do not constitute all possible examples.

A data collection profile may include various permutations of “data selectors”. Data selectors identify data that should be generated. For example, a granularity level, as described above, is an example of a data selector. When the granularity level is set to “error”, data identified as “critical” or “error” may be generated. Other examples include function/method identifiers (e.g., names, class name/method name combinations, etc.), variable names, etc. For example, if the data collection profile indicates that data associated with a particular variable should be generated, an in-application analytics module may generate data indicating the value of a variable each time the value changes. Data selectors may be categorical or specific. For example, code instrumentation may be associated with a category (such as a granularity, data type, error type, etc.) or may be uniquely identified by a particular identifier. Thus, if data associated with a particular category is desired, the data collection profile may indicate the category; if data associated with a single instance of code instrumentation is desired, the data collection profile may indicate the corresponding unique identifier.

A data collection profile may include data selectors that add instrumentation to an application dynamically. For example, the data collection profile might include code that is dynamically injected into an application at a particular location or at a particular time. As another example, the data collection profile might include instructions that are not inserted into the application itself, but still generate related data. For example, the data collection profile might include instructions executed by the in-application analytics module to read and save data located at a particular memory address.

Variations

Although the examples above typically describe detecting triggering criteria and generating a data collection profile to collect additional data related to the triggering criteria, data collection profiles can be generated that reduce the data collected. For example, consider a rule that is triggered when a particular value exceeds a threshold and, in response to triggering of the rule, additional data is collected. An application analytics module may also include a corresponding rule that is triggered when the value falls below the threshold and, in response to the triggering of the corresponding rule, stops collection of the additional data.

Although the descriptions of FIGS. 1 and 2 describe the global analytics modules 104 and 204, respectively, as sending data collection profile B 108/208 to the in-application analytics modules, the global analytics modules 104 and 204 may merely notify the in-application analytics modules that data collection profile B 108/208 is available. The in-application analytics modules may then request data collection profile B 108/208.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium does not include transitory, propagating signals.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

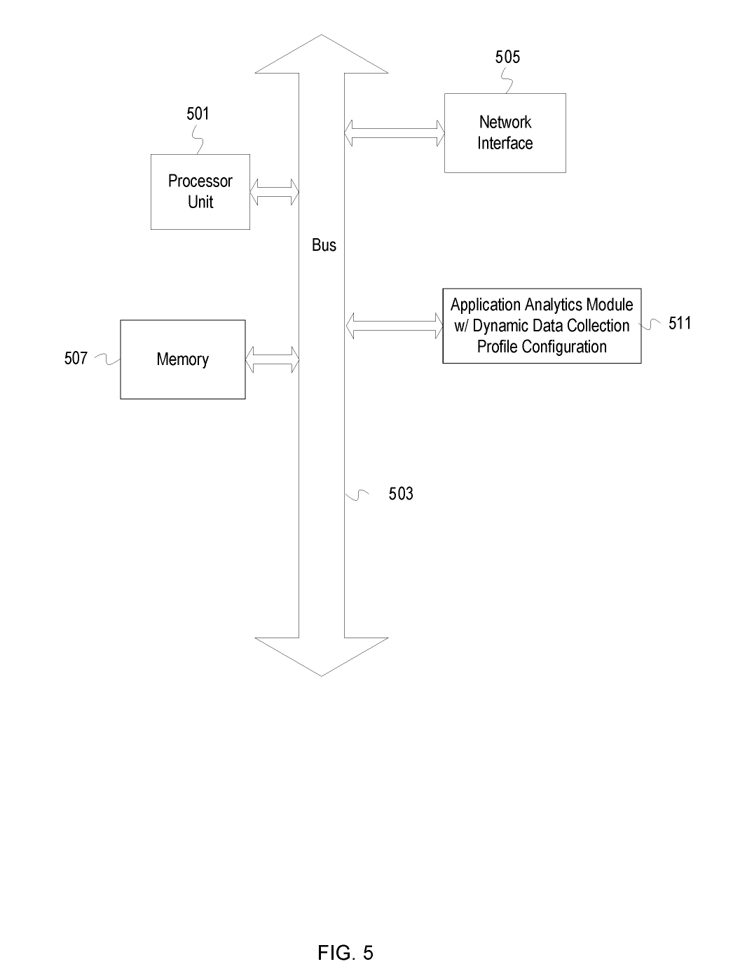

FIG. 5 depicts an example computer system with an application analytics module with dynamic data collection profile configuration. The computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport® bus, InfiniBand® bus, NuBus, etc.) and a network interface 505 (e.g., a Fiber Channel interface, an Ethernet interface, an internet small computer system interface, SONET interface, wireless interface, etc.). The system also includes an application analytics module 511. The application analytics module 511 includes functionality for detecting trigger criteria, generating a data collection profile based, at least in part, on the trigger criteria, and notifying other application analytics modules of the generated data collection profile. Any one of the previously described functionalities may be partially (or entirely) implemented in hardware and/or on the processor unit 501. For example, the functionality may be implemented with an application specific integrated circuit, in logic implemented in the processor unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor unit 501.

While the aspects of the disclosure are described with reference to various implementations and exploitations, it will be understood that these aspects are illustrative and that the scope of the claims is not limited to them. In general, techniques for data collection as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

As used herein, the term “criteria” means one or more criteria. Thus, if an example refers to “triggering criteria,” the triggering criteria may be a single criterion.

As used herein, the term “or” is inclusive unless otherwise explicitly noted. Thus, the phrase “at least one of A, B, or C” is satisfied by any element from the set {A, B, C} or any combination thereof, including multiples of any element.

What is claimed is:

1. A method comprising:
receiving first data generated by a first application analytics module, wherein the first data was generated in accordance with a first data collection profile;
detecting a triggering criterion based, at least in part, on the first data;
in response to detecting the triggering criterion, generating a second data collection profile; and
indicating to a second application analytics module that the second data collection profile is available.

2. The method of claim 1 further comprising:
indicating to the first application analytics module that the second data collection profile is available.

3. The method of claim 2 further comprising:
configuring the first application analytics module and the second application analytics module to generate data in accordance with the second data collection profile.

4. The method of claim 2 further comprising:
identifying the first application analytics module and the second application analytics module as target application analytics modules;
wherein indicating to the first application analytics module that the second data collection profile is available and indicating to the second application analytics module that the second data collection profile is available are performed in response to identifying the first application analytics module and the second application analytics module as target application analytics modules.

5. The method of claim 1, wherein indicating to the second application analytics module that the second data collection profile is available comprises sending the second data collection profile to the second application analytics module.

6. The method of claim 1, wherein detecting the triggering criterion is further based, at least in part, on machine-learning techniques.

7. The method of claim 1, wherein detecting the triggering criterion comprises:
identifying a rule associated with the first data; and
determining that the first data meets a condition specified by the rule.

8. The method of claim 7, wherein generating the second data collection profile comprises:
identifying second data associated with the rule, wherein the second data specifies data that should be collected if the condition specified by the rule is met; and
generating the second data collection profile based, at least in part, on the first data collection profile and the second data.

9. A system comprising:
a first device comprising,
a first processor; and
a first machine readable medium having program code executable by the first processor to cause the first device to,
receive first data generated by a first application analytics module, wherein the first application analytics module executes on a second device, wherein the first data was generated in accordance with a first data collection profile;
detect a triggering criterion based, at least in part, on the first data;
in response to detection of the triggering criterion, generate a second data collection profile; and
indicate to a second application analytics module that the second data collection profile is available, wherein the second application analytics module executes on a third device.

10. The system of claim 9, wherein the program code is further executable by the first processor to cause the first device to:
indicate to the first application analytics module that the second data collection profile is available.

11. The system of claim 10, wherein the program code is further executable by the first processor to cause the first device to:
identify the first application analytics module and the second application analytics module as target application analytics modules;
wherein indication to the first application analytics module that the second data collection profile is available and indication to the second application analytics module that the second data collection profile is available is in response to identification of the first application analytics module and the second application analytics module as target application analytics modules.

12. The system of claim 9, wherein the program code executable by the first processor to cause the first device to indicate to the second application analytics module that the second data collection profile is available comprises program code executable by the first processor to cause the first device to send the second data collection profile to the second application analytics module.

13. The system of claim 9, wherein detection of the triggering criterion is further based, at least in part, on machine-learning techniques.

14. The system of claim 9, wherein the program code executable by the first processor to cause the first device to detect the triggering criterion comprises program code executable by the first processor to cause the first device to:
identify a rule associated with the first data; and
determine that the first data meets a condition specified by the rule.

15. The system of claim 14, wherein the program code executable by the first processor to cause the first device to generate the second data collection profile comprises program code executable by the first processor to cause the first device to:
identify second data associated with the rule, wherein the second data specifies data that should be collected if the condition specified by the rule is met; and
generate the second data collection profile based, at least in part, on the first data collection profile and the second data.

16. The system of claim 9 further comprising:
the second device, wherein the second device comprises,
a second processor; and
a second machine readable medium having program code executable by the second processor to cause the second device to,
generate the first data in accordance with the first data collection profile;
send the first data to the first device;
receive the second data collection profile; and
after reception of the second data collection profile, generate second data in accordance with the second data collection profile.

17. One or more machine readable storage media comprising program code for dynamic data collection profile configuration stored therein, the program code to:
receive first data generated by a first application analytics module, wherein the first application analytics module executes on a second device, wherein the first data was generated in accordance with a first data collection profile;
detect a triggering criterion based, at least in part, on the first data;
in response to detection of the triggering criterion, generate a second data collection profile; and
indicate to a second application analytics module that the second data collection profile is available, wherein the second application analytics module executes on a third device.

18. The machine readable storage media of claim 17, wherein detection of the triggering criterion is further based, at least in part, on machine-learning techniques.

19. The machine readable storage media of claim 17, wherein the program code to detect the triggering criterion comprises program code to:
identify a rule associated with the first data; and
determining that the first data meets a condition specified by the rule.

20. The machine readable storage media of claim 19, wherein the program code to generate the second data collection profile comprises program code to:
identify second data associated with the rule, wherein the second data specifies data that should be collected if the condition specified by the rule is met; and
generate the second data collection profile based, at least in part, on the first data collection profile and the second data.
